(19) United States
(12) Patent Application Publication
(10) Pub. No.: US 2004/0034581 A1
(43) Pub. Date: Feb. 19, 2004

(54) Inventory control and communication system

(75) Inventors: Gordon W. Hill, Arlington, MA (US); John D. Lloyd, Hull, MA (US); Lawrence W. Hill, Eastham, MA (US); Matthew M. Besen, Andover, MA (US)

Correspondence Address: WEINGARTEN, SCHURGIN, GAGNEBIN & LEBOVICI LLP, TEN POST OFFICE SQUARE, BOSTON, MA, 02109, US

(73) Assignees: Visible Inventory, Inc.; Bintel Systems, Inc.

(21) Appl. No.: 10/453,451

(22) Filed: Jun. 3, 2003

Related U.S. Application Data
(63) Continuation-in-part of application No. 09/442,889, filed on Nov. 18, 1999, now abandoned.
(60) Provisional application No. 60/108,843, filed on Nov. 18, 1998.
(60) Provisional application No. 60/136,297, filed on May 27, 1999.

(51) Int. Cl. G06F 17/60

(52) U.S. Cl. 705/28

(57) ABSTRACT

An inventory control and communication system provides automated real-time control of stock levels and ordering in a timely manner so that optimal stock levels are maintained. An inventory sensor that includes a storage unit, or bin, for each stock item or inventory object. One or more transducers are associated with each storage unit to produce a mass/weight signal indicative of the weight of the stock items stored in or at the corresponding storage unit. The signals are transmitted to a computer associated with the inventory sensor, which determines the weight and the number of the inventory objects present in the bin and provides this data as part of the inventory data associated with the inventory object. The inventory data is provided to a host computer that maintains information about the inventory sensor location and the corresponding stock item, such as item weight and supplier information. Threshold values for the minimum and maximum quantity of each stock item are also maintained by the host computer. When the quantity of a stock item reaches the minimum threshold, the host comptuer is operative to send an order to the supplier to restore the stock item to the maximum quantity threshold, or otherwise indicates that a reorder is needed.

### CROSS REFERENCE TO RELATED APPLICATIONS

This application claims priority to U.S. provisional patent applications No. 60/108,843, filed Nov. 18, 1998, entitled Inventory Management System, U.S. provisional patent application No. 60/136,297, filed May 27, 1999, entitled Inventory Control and Communication System. This application is a continuation-in-part to utility patent application No. 09/442,889, filed Nov. 18, 1999 entitled Inventory Control and Communications System.

### STATEMENT REGARDING FEDERALLY SPONSORED RESEARCH OR DEVELOPMENT

Not Applicable

### BACKGROUND OF THE INVENTION

Inventory management systems are known which attempt to keep inventory of stock items at an optimal level based upon factors such as availability, possibility of price increase, lag time to reorder, and predictability of consumption rates. One such system is a Materials Requirements Planning (MRP) system, which is the primary manufacturing module of Enterprise Resource Planning (ERP) systems. Inventory ordering is performed through accurate forecasts of finished product demand and raw material availability, among other factors. Such systems, however, depend upon accurate market forecasting. Another inventory system is known as a “Kanban” system, in which stock items are maintained with minimum and maximum thresholds. When the minimum threshold is reached, maximum threshold. Timely examination of the stock item level is required, however, to ensure that the stock does not run out, and to ensure timely notification to a supplier to effect delivery.

It would be beneficial, therefore, to provide a system which performs automatic replenishment of stock through real-time polling of stock item quantity to avoid the need for periodic manual inspection of quantity and the need to maintain accurate market forecasts.

### BRIEF SUMMARY OF THE INVENTION

An inventory control and communication system provides automated real-time control of stock levels and ordering in a timely manner so that optimal stock levels are maintained. An inventory sensor includes a storage unit, or bin, for each stock item or inventory object and one or more transducers associated with each storage unit are operative to produce a mass/weight signal indicative of the weight of the stock items stored in or at the corresponding storage unit. The signals are transmitted to a computer associated with the inventory sensor, which determines the weight and number of the inventory objects present in the bin and provides this count as part of the inventory data associated with the inventory object. The inventory data is provided to a host computer that maintains the inventory data along with information about the inventory sensor location and the corresponding stock item, such as item weight and supplier information. Threshold values for the minimum and maximum quantity of each stock item are also maintained by the host computer. When the quantity of a stock item reaches the minimum threshold, the host comptuer is operative to send an order or alert to the supplier or other designated destination or individual to restore the stock item to the maximum quantity threshold, or otherwise indicates that a reorder is needed.

The quantity of the stock item is determined by the computer associated with the inventory sensor from the transducer signals and the known weight of the predetermined stock item at the particular storage unit. The transducers, such as strain gauges, are disposed on or at each storage unit in such a manner so as to be sensitive to the weight of the stock items at the storage unit. Multiple transducers may be used to measure the weight of a single storage unit.

### BRIEF DESCRIPTION OF THE SEVERAL VIEWS OF THE DRAWING

The invention will be more fully understood with reference to the following detailed description and drawings, of which:

FIG. 1 is a block diagram of the inventory control and communication system as defined by the present invention;

FIG. 2 is a context diagram of the system of FIG. 1;

FIG. 3 is a block diagram of the database and query GUI as used in the present invention;

FIG. 4 shows a block diagram of a storage transmission node;

FIG. 5 shows a flowchart of the storage transmission node logic;

FIG. 6 shows the packet structure of the transducer signal packet sent from the storage transmission node;

FIG. 7 is a block diagram of another embodiment of the inventory control system as defined by the present invention;

FIG. 8 is a block diagram of an inventory sensor suitable for use with the embodiment of the inventory control system depicted in FIG. 7; and

FIG. 9 is a block diagram of a node controller suitable for use with the embodiment of the inventory control system depicted in FIG. 7.

### DETAILED DESCRIPTION OF THE INVENTION

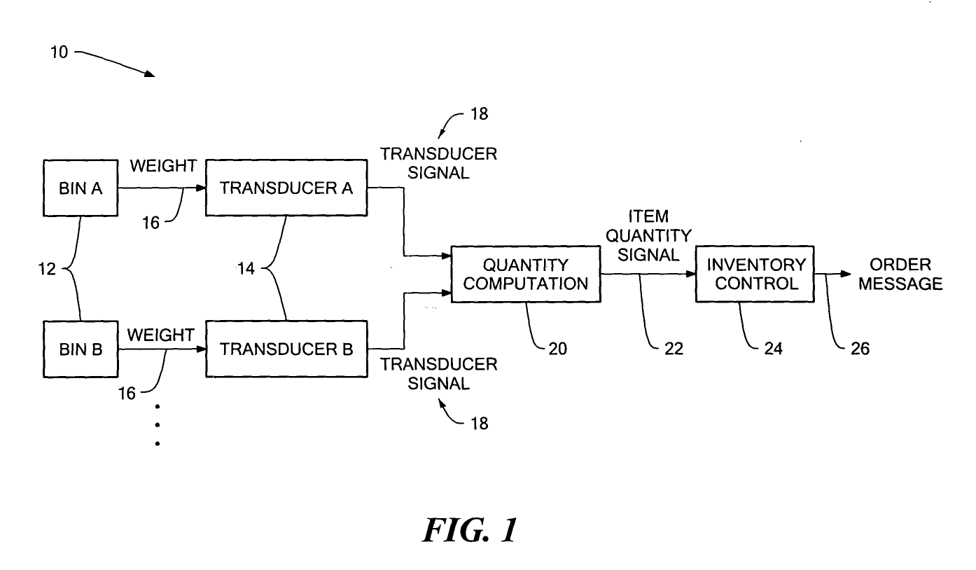

Referring to FIG. 1, a block diagram of the inventory control and communication system 10 is shown as defined herein. One or more storage units, such as bins 12, store a quantity of a predetermined item. The quantity is proportional to the weight of the loaded bin 12. A transducer 14 senses the weight 16 of the bin 12, and produces a transducer signal 18 indicative thereof. The transducer signal 18 and the weight of the predetermined item is then used by quantity computation 20 to compute the quantity of the item in the respective bin 12. An item quantity signal 22 is sent to inventory control 24 which compares the quantity to minimum quantity thresholds for the particular item. If the quantity of a particular item is below the minimum threshold, inventory control 24 sends an order message 26 to a supplier to restock the item.

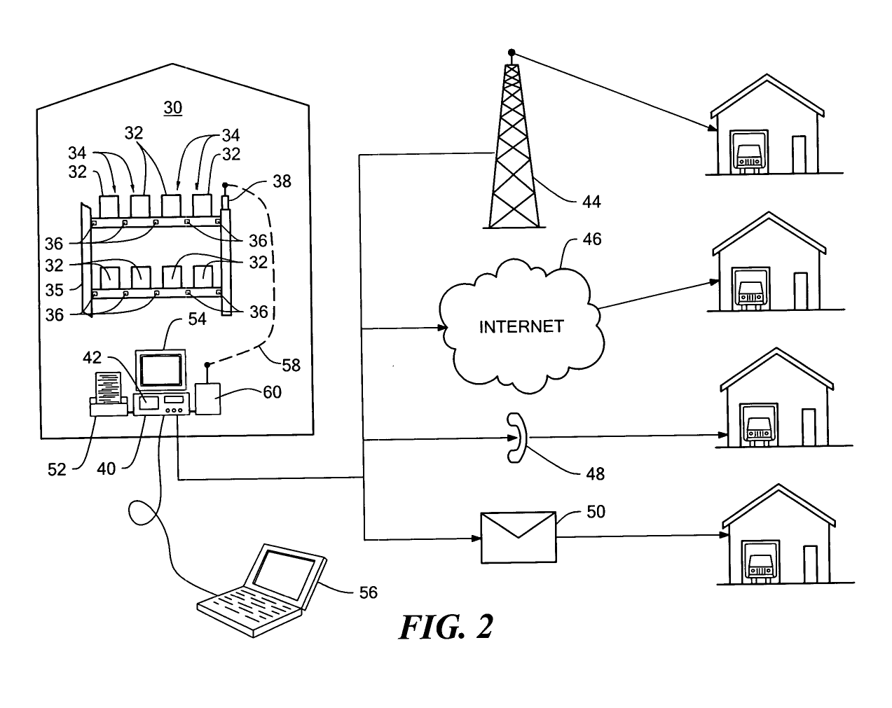

Referring to FIGS. 1 and 2, the inventory control and communication system 10 as described above is shown in the context of a customer facility 30. A plurality of storage units 32 are located at a facility 30, such as a warehouse or manufacturing site. Each storage unit 32 is adapted to store a predetermined item 34 of a known weight. The storage units 32, described further below, may be bins, pallets, shelves, fluid tanks, wire spools, or other storage apparatus, and may be mounted in rows on a rack 34 or free standing, depending on the items so stored. One or more transducers 36 are associated with each storage unit, and located so as to sense the weight of the stored items 34. Each transducer 36 is connected to a storage transmission node 38, described further below, and sends to the storage transmission node 38 a transducer signal 18 indicative of weight. The storage transmission node 38 builds a transducer signal packet including one or more transducer signals according to a predetermined protocol.

The transducer signal packet is sent to a central inventory server 40, which receives transducer signal packets from other storage transmission nodes 38 at the facility 30. The central inventory server 40 is connected to an inventory database 42, which stores information about the item corresponding to each storage unit. For each storage unit 32, the weight of the item stored therein is maintained, as well as a minimum and maximum quantity threshold quantity for each item. The transducer signal packets are used to compute the quantity of the item remaining in the storage units, and are compared to the minimum quantity threshold stored in the inventory database 42.

The inventory database 42 also contains supplier information for each item. The inventory server 40 will send an order to the supplier by any suitable means, such as via Internet 46, voice 48, cellular 44, or via paper mail 50 by printing an order on the attached printer 52. Alternatively, the inventory server 40 may send quantity information without requesting an order.

The inventory server 40 has a graphical user interface (GUI), described further below, for performing various inventory query functions. The GUI can be accessed locally through the server monitor 54, or accessed remotely from another computer 56.

Transducer Polling

As indicated above in FIG. 2, each strain gauge 36 is connected to a storage transmission node 38 local to the storage units 32. Each storage transmission node 38 may be connected to strain gauges 36 corresponding to multiple storage units. Readings from each of the strain gauges 36 are transmitted to the central inventory server 40.

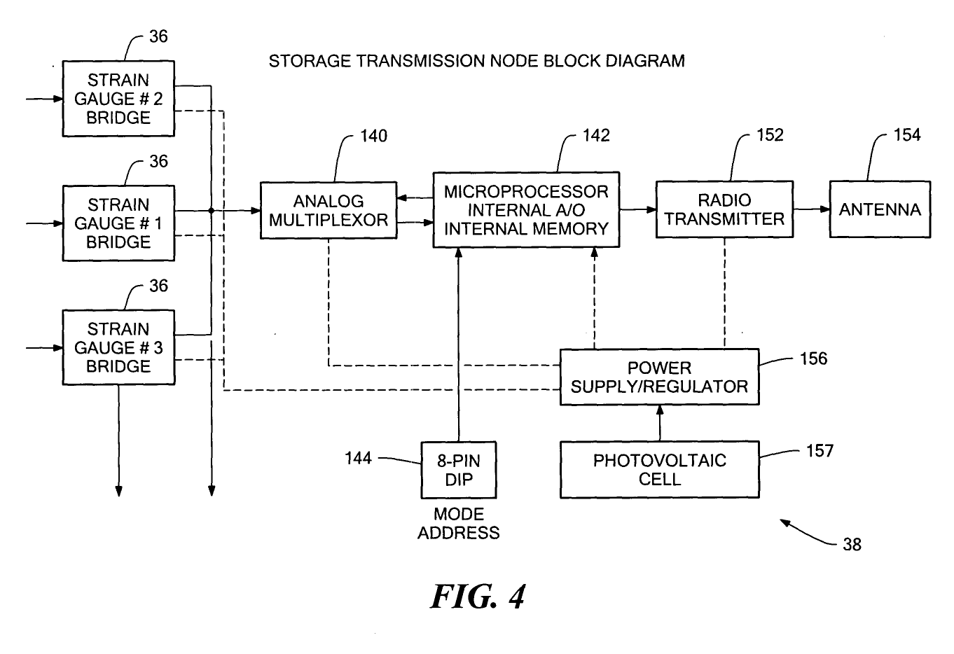

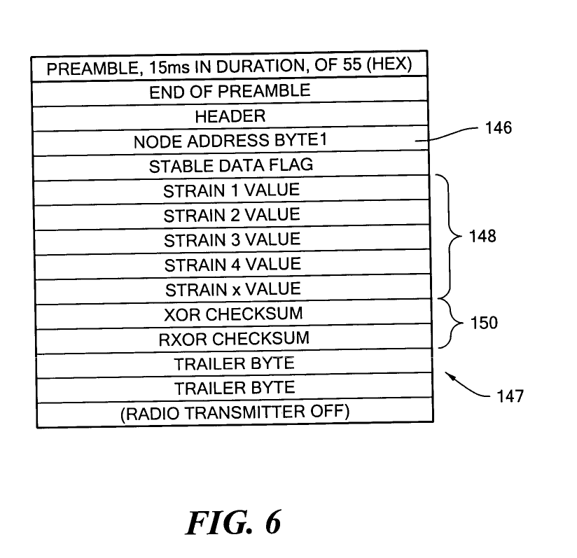

Referring to FIG. 4, a block diagram of the storage transmission node 38 is shown. Each strain gauge 36 is connected to a multiplexor 140. Multiplexor 140 polls each strain gauge 36 and sends the signals to the processor 142. The processor builds a transducer signal packet containing the transducer signals. A node address, identifying the storage transmission node, is read from a DIP switch 144. The node address distinguishes multiple storage transmission nodes which may be sending transducer signal packets to the central inventory server 40. The transducer signal packet 147 is shown in FIG. 6, and includes the node address 146, values for each strain gauge reading 148, and checksum fields 150. The transducer signal packet is sent to a radio transmitter 152 for transmission to the central inventory server 40 through an antenna 154. The storage unit node 38 is powered through a power supply/regulator 156, which may include a photovoltaic cell 157.

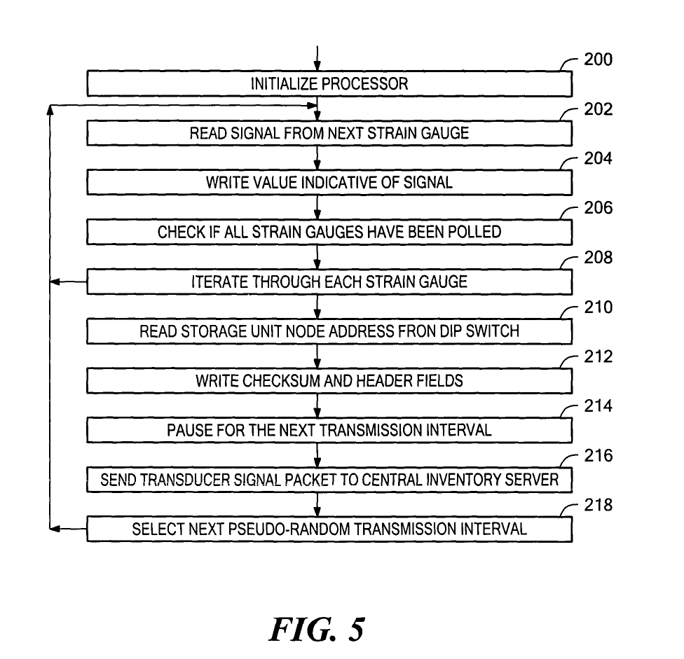

A flowchart of the storage transmission node logic is shown in FIG. 5. The processor is initialized at step 200 to begin polling at the first strain gauge. The signal from the next strain gauge is read, as depicted at step 202. A value indicative of the signal is written to the proper position in the transducer signal packet, as shown at step 204. A sampling algorithm may be employed to provide verification through multiple successive reads. A check is made, as disclosed at step 206 to determine if all strain gauges have been polled. If not, iterate through each strain gauge in sequence, as depicted in step 208. When all strain gauges have been read, the storage transmission node address is read from DIP switch 144, as depicted in step 210. Checksum and header fields are written to the transducer signal packet, shown in step 212. A pause for the next pseudo-random transmission interval is performed, as disclosed in step 214 and described further below. When the transmission interval elapses, the transducer signal packet is sent to the central inventory server 40, as shown in step 216. The next pseudo-random transmission interval is selected, as shown at step 218, and control reverts to step 202.

Signal Packet Transmission

On a periodic basis, as indicated above with respect to FIG. 1, each storage transmission node 38 polls each transducer 36 connected to it in sequence to cause the transducer to send the transducer signal 18. Each storage transmission node 38, after polling each transducer 36, builds and sends the transducer signal packet to the central inventory server 40. In a preferred embodiment, transmission to the inventory server 40 is via a RF link 58 to an RF receiver 60, but can be by any suitable means, such as Internet, power line, modem, LAN, WAN, IR, or other communication link.

Typically there will be a plurality of storage transmission nodes 38 at a facility. Each of these will be sending periodic transducer signal packets containing the latest transducer polling sequence. Transmission intervals to the inventory server 40 are therefore staggered pseudo-randomly, to avoid collisions between simultaneous transducer signal packets. Collisions which do occur, however, are unlikely to repeatedly affect the same storage transmission node, due to the pseudo-random staggering. Since the pseudo-random staggering makes it unlikely that a collision will repeatedly affect the same transmission node, subsequent transducer signal packets will ensure that the quantity counts remain current.

In a preferred embodiment, the storage transmission nodes comprise transmit only radios. Such radios do not require a two way protocol, therefore saving bandwidth. Accordingly, a pseudo-random interval avoids collisions without requiring a duplex protocol. Further, the interval determination uses the address of the storage transmission node, ensuring that two storage transmission nodes will not collide on consecutive cycles.

Referring again to FIGS. 1 and 6, upon receipt by the central inventory server 40 the transducer signal packet is used to compute the quantity of items stored in each storage unit 32. For each storage unit, information concerning the corresponding storage transmission node 38, and the corresponding transducer signal values from the transducer signal packet (148 and 147 respectively, FIG. 6) are used to compute the total weight contained in or at the storage unit. The quantity is determined from the individual item weight. The quantity is compared to minimum order threshold values, which indicate when an order is to be generated. When the quantity falls below the minimum threshold, an order is generated to replenish the quantity to a maximum quantity for the item. Also contained in the database 42 are supplier information and order methods, such as Internet, paper mail, or telephone, so that an automatic order may be generated and sent.

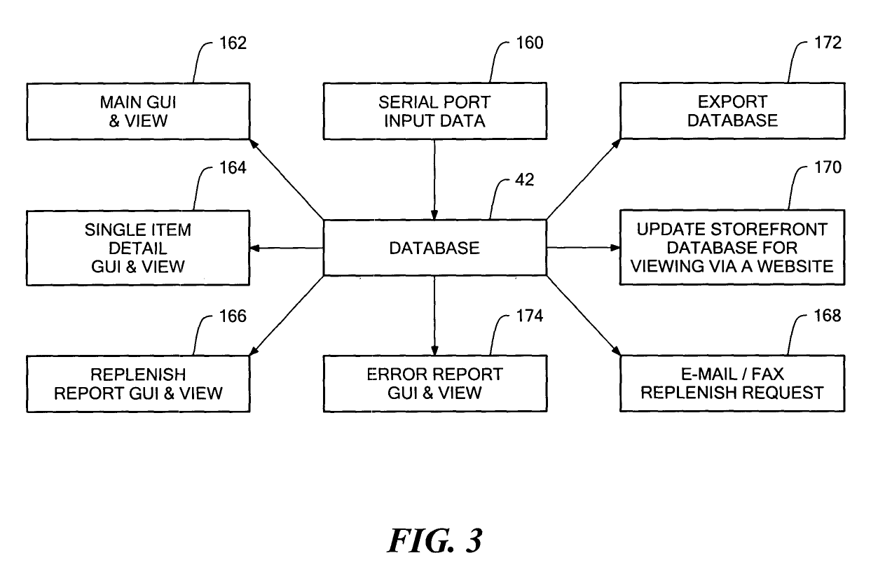

The database 42 is also connected to a GUI for various user interactions, shown in FIG. 3. The database is populated through a serial port 160 from the receiver 60 (FIG. 1). A main view screen 162 provides options allowing a user to access the various functions enumerated below. A single item detail view 164 screen allows graphical information concerning quantity of individual parts in relation to the minimum and maximum quantity thresholds. A replenish report view screen 166 provides information concerning frequency of orders placed for a particular item. A replenish request view screen 168 allows a manual item order to be placed via e-mail or fax. A storefront view screen 170 allows remote Internet access. An export database view screen 172 allows downloading to a remote client. An error report view screen 172 provides diagnostic feedback about system functions. Other queries and access to the database can be envisioned in addition to those enumerated here.

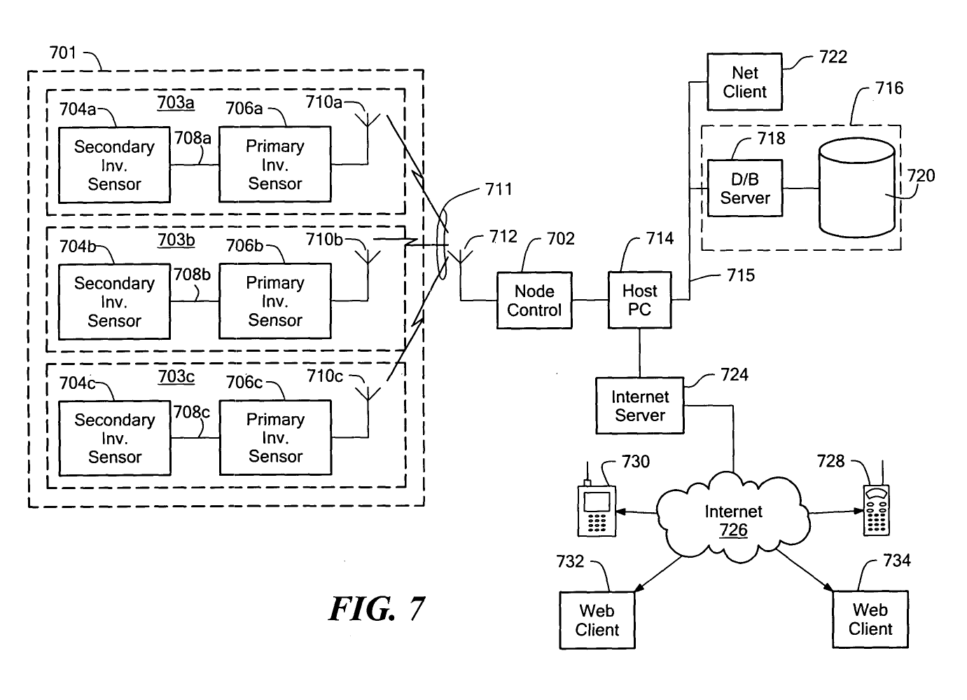

FIG. 7 depicts another embodiment of the inventory control system described herein. Inventory control system 700 includes an inventory sensor system 701 coupled to a node controller 702 via a primary sensor network 711. The node controller 702 is coupled to a host computer 714. The host computer is coupled via a network 715 to a database system 716 that includes a database server 718 and a database storage device 720. One or more net clients 722 can be coupled to the network 715 to access the host computer 714 and retrieve and analyze data from the database system 716. The host computer 714 can also be coupled to a internet server 724 and thereby coupled to the Internet 726. The host computer 714 can then provide e-mail alerts and orders or voice mail alerts and orders to users and suppliers via cell-phones 728, PDAs 730 or one or more web clients 732 and 734. In addition, the web clients 732, 734 and the net client 722 may access the host computer 714 and retrieve, analyze and process data from the database system 716 separately from the host computer 714.

The inventory sensor system 701 includes at least one networked inventory sensor, and in the illustrative embodiment there are depicted a plurality of network inventory sensors 703a, 703b, and 703c each of which includes one or more inventory sensors networked together. The one or more inventory sensors includes at least one primary inventory sensor and if more than one inventory sensor is present these are connected to the primary inventory sensor as secondary inventory sensors. In the embodiment depicted in FIG. 7, each of the plurality of network inventory sensors 703a, 703b, and 703c includes a primary inventory sensor 706a, 706b, and 706c respectively and a secondary sensor 704a, 704b, and 704c respectively. Each secondary inventory sensor 704a-c is communicably coupled to the corresponding primary inventory sensor 701a-c, respectively via a corresponding sensor network 708a-c. If there were more than one secondary inventory sensor present within one of the networks of inventory sensors 701a-c, the additional secondary sensors would be coupled to the other second inventory sensors in that particular network of sensors and to the corresponding primary inventory sensor via the corresponding sensor network 708a-708c, respectively.

As will be explained below, each inventory sensor senses the presence of inventory objects and provides inventory data relating to the type and quantity of inventory objects present at the respective sensor. As will be explained below, the respective inventory sensor can provide inventory data periodically or in a preferred embodiment, the inventory data is provided only after the weight of the corresponding inventory object changes. The inventory sensors also provide other data that is necessary for the control and operation of the respective sensor such as inventory sensor calibration and inventory sensor configuration data. Secondary inventory sensors 704a-c, provide this inventory data to the corresponding primary inventory sensor, 706a-c, respectively, via the corresponding inventory sensor network 708a-c, respectively. The primary inventory sensor also provides inventory data as an output. The respective primary sensor 706a-c combines the inventory data it has provided along with the inventory data received from the secondary inventory sensors via the respective sensor network 708a-c. The respective primary inventory sensor 706a-c provides this combined inventory data to the node controller 702 via a primary sensor network 711.

The primary sensor network 711 interconnects each primary inventory sensor 706a-c with the node controller 702 to transfer inventory data from each sensor coupled thereto, configuration and calibration data for the various sensors coupled thereto, and communicates commands and data to the various secondary sensors connected thereto. The primary sensor network 711 can interconnect each respective primary inventory sensor using a variety of methods that may include, but are not limited to, wireless optical transmission, wireless RF transmission, optical network transmission, and electrical network transmission such as a LAN or Ethernet network. In the embodiment depicted in FIG. 7 the master sensor network utilizes wireless RF data transmission to communicate data between the respective primary inventory sensors 706a-706c and the node controller 702. The RF data transmission used herein is between the wireless RF antenna 710a, 710b, and 710c coupled to the corresponding primary inventory sensor 706a, 706b, and 706c respectively, and a wireless RF antenna 712 coupled to the node controller 702. Although in the illustrative embodiment in FIG. 7 depicts each primary inventory sensor being coupled via a wireless RF data signal to the node controller, various methods may be used to connect each individual primary inventory sensor to the node controller. For example, primary inventory sensors that are located closer to the node controller may be coupled using a short range electrical or optical network or a free space optical signal. Primary inventory sensors that are farther away from the node controller may use wireless RF data signals or longer range LANS or WANs to interconnect to the node controller.

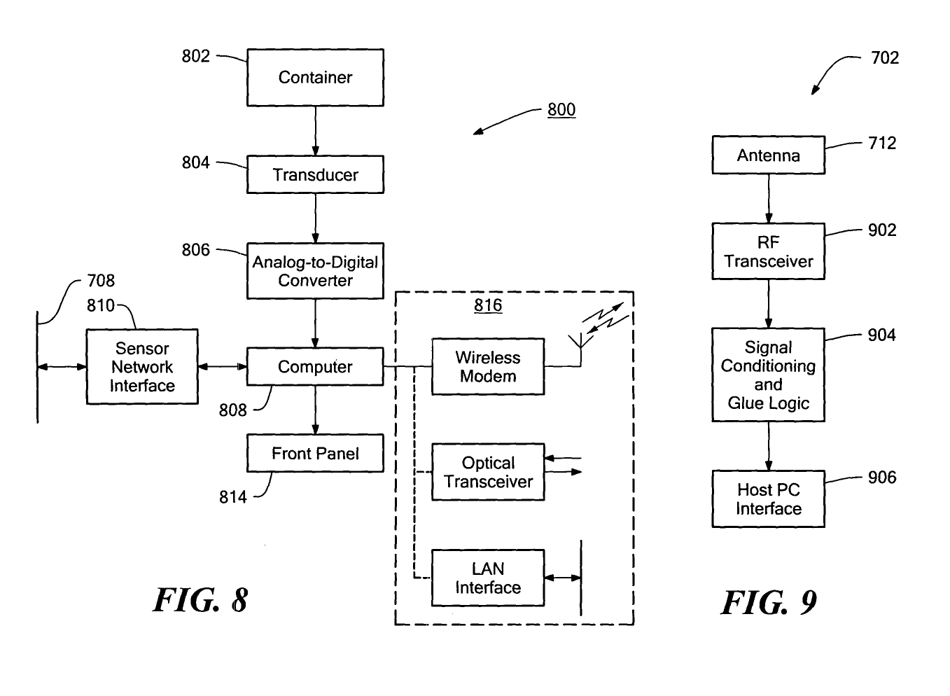

FIG. 8 depicts an inventory sensor 800 suitable for use as a secondary inventory sensor or, with the addition of a primary network link, as a primary inventory sensor. A suitable inventory sensor 800 includes a bin 802 that contains a quantity of inventory objects (not shown) that are to be counted. The bin 802 rests on a transducer 804 that is capable of providing an electrical signal that is indicative of the mass/weight of the quantity of the inventory objects that are present in the bin 802. The mass transducer 804 can be any suitable mass-sensing element known in the art. For example the mass transducer can be, without limitation a strain gauge, load cell, pressure sensor, optical sensor, liquid sensor, or sonic sensor that is capable of providing an electrical mass/weight signal having at least one characteristic that changes as a known function of the mass/weight of the quantity of the inventory objects that are being measured. The transducer 804 provides the output electrical mass/weight signal to an analog-to-digital converter 806 that may include front end processing, filtering, and signal conditioning of the electrical mass/weight signal provided by the transducer 804. The analog-to-digital converter 806 converts the analog electrical signal into a binary signal that is indicative of the mass of the quantity of inventory objects in the bin 802. The analog-to-digital converter provides the binary signal to the computer 808 for processing. The computer 808 may be a microcomputer including a microprocessor or a microcontroller.

The computer 808 processes the binary mass/weight signal to find the desired inventory data. In one embodiment, the computer continuously monitors and processes the mass/weight signal but only provides an output of inventory data after a change in the mass/weight signal has been detected or if a predetermined time period has elapsed since the last data output. By not periodically transmitting inventory data, the inventory sensor is able to use less power and thus conserve battery life in the event that the inventory sensor is battery powered. In addition, a settling time may be built into each inventory sensor. The settling time is the length of a dead-time period in which the computer 808 does not transmit inventory data after a change in the mass/weight signal has been detected. For example, a user removing inventory objects from a bin may take too many and put some of the inventory objects back into the bin 802. The settling time is used to prevent this occurrence from distorting the count of the inventory objects.

In addition, the computer 808 configures and calibrates the inventory sensor to ensure an accurate count of the inventory objects. The inventory sensors can be powered by on-site electrical power or by a battery power supply. The status of the on-site electrical power or the battery status can be included in the inventory data and stored in the database so that power monitoring of the inventory sensors is available.

The computer 808 includes a front panel 814 that includes a display portion that is operative to display predetermined user selected information such as inventory data, calibration data, and configuration data. In addition, messages sent to the respective inventory sensor from the host computer can be displayed on the display portion as well. The front panel further includes one or more button controls to provide for user control of certain predetermined operations of the computer 808. For example, prior to use, the inventory system must be zeroed so that the weight of the bin 802 is not included in the subsequent calculations. Typically a button controller on the front panel 814 of the computer 808 is used to instruct the computer to set the sensor output to zero before the user has added any inventory objects from the bin. Sensor calibration may be then accomplished by placing a known quantity of inventory objects into the bin 802, receiving the digital representation of the mass/weight of the inventory objects placed into the bin 802 and dividing the number of objects by the measured mass/weight of the objects. This calibration procedure is necessary so that as the mass/weight changes due to the removal and replenishment of inventory objects, an accurate count of the inventory objects can be maintained. The display portion of the front panel can be used to display data relating to the operation of the sensor, such as the current mass/weight of the inventory objects currently in the bin 802, the description of the inventory objects in the bin 802, the quantity of objects contained in the bin 802, that status of the particular sensor, and any necessary configuration data.

The sensor further includes an interface 810 to the sensor network 708 so that data regarding the operation of the sensor including inventory data and status and configuration data can be provided to other sensors and, in the event that the sensor is a secondary sensor, to the corresponding primary inventory sensor. In a preferred embodiment, the sensor network 808 is the I²C Bus developed by Philips Corp, information regarding the I²C Bus can be found at www.philipslogic.com/i2c and the corresponding handbook, application notes, application, and design support may be found at www.semiconductors.philips.com/i2c. The I²C bus is a two-wire bus for controlling and monitoring applications in computing, communications, and manufacturing environments. In the illustrative embodiment, there can be 24 secondary inventory sensors and one primary inventory sensor in a single networked sensor system. Other networks can be used, for example other multi-drop bus architectures, TDMA buses, or and RS-485 bus architecture can be used. In general parallel busses are not optimal in this system so that serial busses are preferred.

In the event that the sensor is to be a primary inventory sensor, the basic sensor will have attached to the computer 808, a primary network link interface 816. The primary network link interface 816 couples the corresponding primary inventory sensor 706a-c to the node controller 702. In the illustrative embodiment, a wireless RF duplex modem is used to communicate between the primary inventory sensor and the node controller. The duplex wireless modem includes an RF transceiver at both the respective primary inventory sensor and the node controller to send and receive digital data transmissions to and from the node controller respectively. The wireless modems communicate via signals sent and received via antennas 710a-c and 712. In the illustrative embodiment, each transmission is acknowledged by the receiving system. Alternatively, a wireless optical communications system can be used that includes a separate optical transceiver that is coupled to each individual primary inventory sensor and one that is coupled to the node controller. In another embodiment, a network, either electrical or optical, may be used to coupled the primary inventory sensors to the node controller. The network may be a LAN, Ethernet, WAN, or other suitable electrical or optical network. A suitable sensor is the iSeries sensor products available from Visible Inventory, www.visibleinventory.com.

The node controller 702 is depicted in greater detail in FIG. 9. The node controller 702 includes an interface 902 to the primary inventory sensor network that coupled the primary inventory sensors 706a-c to the node controller 702 as depicted in FIG. 7. In the illustrative embodiment, the interface is a wireless RF modem having an antenna 712 coupled to a radio transceiver 902. Signal conditioning circuitry and glue logic 904 couple the wireless modem to the external network connection 906 where inventory data 714 is provided to external computers and database systems. The Signal conditioning circuitry and glue logic 904 condition data that is both received at and that is to be transmitted by the interface 902. Although in the illustrated embodiment the interface 902 is a wireless RF connection, the interface must be mutually compatible with the primary inventory sensor network 711. Thus, in addition to a wireless RF interface, the interface 902 may be an optical or electrical interface as well.

The host computer 714 provides the interface to the stored data. The host computer receives the inventory data and other sensor data from the node controller 702 and stores the data in a database system 716. The database system 716 typically includes a database server 718 and a database storage device 720 where the inventory data and sensor data is stored. The stored data can include various data fields associated with a particular inventory sensor. The data may include the current quantity of the inventory object, the part-number of the corresponding inventory object, a description of the inventory object, the location of the inventory sensor, the part status, and specific instructions, such as re-ordering instructions and e-mail addresses and set forms to send to the desired recipients. In addition, data is associated with each inventory object and stored in the database system. This associated inventory object data can include suppliers of the inventory object, the re-order quantities of the inventory object, the replenishment levels of the inventory object, the over-stock levels of the inventory object, the order lead times, the critical quantity levels of the inventory object, and the maximum quantity level of the inventory object.

The host computer 714 is able to continuously update the inventory data associated with the inventory objects at each inventory sensor in the database system 716 as the respective inventory data is received. Thus, the inventory data stored on the database system 716 can be processed in nearly real-time. This processing, which may be performed by the host computer 714 or a net client 722 coupled via network 715 or a web client 732, 734 coupled via the Internet 726 and web server 724 can include comparing the quantity levels of the inventory objects to predetermined threshold levels so that alerts or automatic orders of the particular inventory object may be initiated when quantities of the inventory object fall below the previously determined critical or replenishment levels.

As noted above, the host computer 714 can be coupled to the internet 726 via an internet server 724 allowing web based clients 732 and 734 access to the stored inventory data via the host computer 714. In addition, in response to the inventory data stored in the database system 716, the host computer 714, web clients 732, 734, or network client 722 can automatically provide e-mail notification or other voice messaging to cell phone users 728, PDA users 730, or other net clients or web-based clients of various real-time situations. These real-time situations can relate to particular inventory objects reaching replenishment levels, critical levels, or over-stock levels. In addition, the host computer 714, the net client 722, or web clients 732, 734 can automatically e-mail suppliers, re-ordering predetermined specific amounts of the particular inventory object associated with the particular object and stored in the database system 716 as described above. Also, the host computer 714, net client 722 or web client 732, 734 can provide users with graphical or textual data regarding the current status of each inventory object. Data may be color coded to visually alert users to varying conditions within the inventory sensor network. These conditions may relate to both inventory levels and inventory sensor status. In addition, historical inventory data may be used and analyzed to enable the optimization of the required quantities of the inventory objects. A suitable software package for the host computer and also the net and web clients is the SuppliLink Software available from Visible Inventory, www.visibleinventory.com.

Those skilled in the art should readily appreciate that the programs defining the functions described herein can be delivered to a computer in many forms, including, but not limited to: (a) information permanently stored on non-writable storage media (e.g., read-only memory devices within a computer such as ROM or CD-ROM disks readable by a computer I/O attachment; (b) information alterably stored on writable storage medial (e.g., floppy disks, tapes read/write optical media and hard drives); or (c) information conveyed to a computer through a communication media, for example, using baseband signaling or broadband signaling techniques, such as over computer or telephone networks via a modem. The present embodiments may be implemented in a software executable out of a memory by a processor. Alternatively, the presently described functions may be embodied in part or in whole using hardware components such as Application Specific Integrated Circuits (ASICs), state machines, controllers or other hardware components or devices, or a combination of hardware components and software.

Those of ordinary skill in the art should further appreciate that variations to and modification of the above-described methods and apparatus for providing automated inventory computation and ordering may be made without departing from the inventive concepts disclosed herein. Accordingly, the invention should be viewed as limited solely by the scope and spirit of the appended claims.

1. A system for determining the quantity of at least one inventory object comprising:
at least one inventory sensor operative to provide inventory data corresponding to said inventory objects associated with said inventory sensor;
a database system
a host computer coupled to the sensor and operative to receive said inventory data said host computer further coupled to said database system, wherein said host computer is operative to store said inventory data in said database system and wherein said host computer is operative to process said inventory data and to provide output messages regarding said status of said inventory object.

2. The system of claim 1 wherein the at least one inventory object is a plurality of inventory objects and wherein the at least one inventory sensor is a plurality of inventory sensors, each inventory sensor corresponding to one of said plurality of inventory objects, and wherein one of said plurality of inventory sensors is a primary inventory sensor and the remaining are secondary inventory sensors, and wherein the secondary inventory sensors are connected via a sensor network to one another, and to said primary inventory sensor, and wherein said primary inventory sensor combines said inventory data from each secondary inventory sensor with said primary inventory sensor inventory data and wherein said primary inventory sensor is coupled to said host computer and provides said combined inventory data thereto.

3. The system of claim 1 wherein an inventory sensor includes:
a storage unit adapted to store a quantity of a predetermined item of known weight;
a transducer associated with the storage unit and operative to provide a transducer signal indicative of the mass of the items located in said storage unit; and
a computer operable to receive said transducer signal from said transducer,
wherein said computer is further operable to compute said inventory data of said items in said storage unit using said transducer signal and said known weight.

4. The system of claim 3 wherein said transducer signal is produced at regular, periodic intervals according to predetermined logic.

5. The system of claim 3 wherein said inventory data is computed at regular, periodic intervals according to predetermined logic.

6. The system of claim 3 wherein said inventory data is provided to said host computer only after a change in the transducer signal.

7. The system of claim 3 wherein said computer in said inventory sensor defines a settling time associated with the respective inventory sensor wherein said settling time is a dead-time after a change is detected in said transducer signal during which said inventory data is not provided to said host computer.

8. The system of claim 1 further comprising an RF link operable to transport said inventory data from said primary inventory sensor to said host computer.

9. The system of claim 1 further including a network interface coupled to said host computer and to a network and said host computer operative to send an order via e-mail over said network to a supplier, wherein said order is sent when said quantity equals a predetermined threshold.

10. The system of claim 2 wherein said transducer signal is a voltage signal proportional to said weight of said items.

11. The system of claim 1 wherein said transducer is selected from the group consisting of a strain gauge, a piezoelectric sensor, load cell, optical sensor, and a pressure sensitive resistor.

12. The system of claim 1 wherein said inventory data includes a list indicative of which of said predetermined stock corresponds to each of said storage units, and further indicative of which of said transducers corresponds to each of said storage units.

13. The system as in claim 1 wherein said transducer is mass sensitive.

14. The system as in claim 3 wherein said storage unit is an open top bin.

15. The system as in claim 3 wherein said storage unit is a pallet.

16. The system as in claim 3 wherein said storage unit is a tank adapted to store fluid.

17. The system as in claim 3 wherein said storage unit is an elongated cylindrical shape adapted to store a spool in rotational communication therewith.

18. The system as in claim 3 wherein said inventory sensor further includes a display capable of displaying predetermined data and messages.

19. The system as in claim 3 wherein said inventory sensor further includes switches coupled to said computer and operative to initiate a predetermined program.

20. The system as in claim 19 wherein said predetermined program is a zero calibration routine.

21. The system as in claim 19 wherein said predetermined program is an inventory sensor calibration routine.

22. A method of inventory management for automatic replenishment of stock items through real-time inventory calculation comprising:
providing a storage unit adapted to store a quantity of a predetermined item of a known weight;
disposing a transducer operable to provide a transducer signal indicative of the weight of said storage units;
providing said transducer signal;
computing, from said transducer signal and said known weight inventory data including the quantity of predetermined stock items stored at said storage units.

23. The method as in claim 22 further comprising the steps of
transmitting, to said host computer, said inventory data.

24. The method of claim 22 wherein said step of transmitting is followed by comparing said inventory data to a predetermined threshold.

25. The method of claim 24 further comprising sending an order to a supplier when said quantity equals said predetermined threshold.

26. The method of claim 22 wherein said step of computing is performed at regular, periodic intervals according to predetermined logic. 27. The method of claim 22 wherein said step of transmitting to said central inventory server is via an RF link.
